(19) United States
(12) Patent Application Publication
(10) Pub. No.: US 2025/0041819 A1
(43) Pub. Date: Feb. 6, 2025

(54) Capsule Gelation Quenching Unit

(71) Applicant: Microcaps AG, Schlieren (CH)

(72) Inventors: Luca Di Tizio, Cham (CH); Christian Burkard, Zürich (CH); David Schaffner, Rheinfelden (CH); Morgane Roquelaure, Zürich (CH)

(21) Appl. No.: 18/714,806

(22) PCT Filed: Nov. 30, 2022
(86) PCT No.: PCT/EP2022/083796

§ 371 Date: May 30, 2024

(30) Foreign Application Priority Data
Dec. 2, 2021 (CH) CH070637/2021

(51) Int. Cl. B01J 13/04; B01J 13/20

(52) U.S. Cl. CPC B01J 13/046; B01J 13/20

(57) ABSTRACT

Disclosed herein is a capsule gelation quenching unit for suspending capsule gelation, the capsule gelation quenching unit including a tubular column including a longitudinally arranged dispersion channel, wherein the dispersion channel is configured for transporting a dispersion of gelled capsules in a continuous phase along a longitudinal direction of the tubular column through the tubular column, and wherein the tubular column further includes a first mesh unit; a cross-flow fluid inlet unit, wherein the cross-flow fluid inlet unit is configured such that a cross-flow fluid can be introduced into the dispersion channel such that the introduced cross-flow fluid flows transversely to the longitudinal direction of the tubular column; and wherein the cross-flow fluid inlet unit is configured such that the cross-flow fluid flows through the first mesh unit.

### CROSS-REFERENCE TO RELATED APPLICATIONS

This application is the United States national phase of International Patent Application No. PCT/EP2022/083796 filed Nov. 30, 2022, and claims priority to Swiss Patent Application No. CH070637/2021 filed Dec. 2, 2021, the disclosures of each of which are hereby incorporated by reference in their entireties.

### BACKGROUND

### Field of Disclosure

The present invention lies in the technical field of capsule production, for example in microcapsule production, and relates to a capsule gelation quenching unit, a method for suspending capsule gelation and a capsule production device.

### Description of Art

Capsules, for example microcapsules with particle sizes of less than 3 mm, or of less than 1 mm, have found widespread application in the field of pharmaceutics, cosmetics, diagnostics, food and material science. Such capsules may be produced from an emulsion of monodisperse droplets in a continuous phase. Monodispersity increases stability, allows to accurately control volumes in multiple chemical or biological reactions and enables the production of periodic structures. Microfluidics offers an exquisite platform to precisely form monodisperse droplets. The monodisperse droplets can be cured for generating microcapsules for encapsulation of active ingredients such as drugs, fragrances, flavors, peptides, living material, such as bacteria or phages etc. fertilizers, pesticides, and other active substances for well-being.

In many cases, capsule formation is performed by providing capsule-forming, for example shell-forming, reagents as a dispersion or emulsion of a dispersed phase in a continuous phase. Droplets are then formed, which are later cured to produce the capsules. In some examples, curing may include a change of temperature, i.e., cooling of a molten capsule forming reagent, or reacting the capsule forming reagent with another agent to form a capsule shell. A prominent example is the ion exchange of a water soluble polysaccharide salt, for example sodium alginate, with a cation, such as Ca²⁺, to form a water insoluble capsule shell. The advantage of using droplets is that the size of the droplets can be accurately controlled. A particular suitable device and method therefor is disclosed in WO 2021 037 999 A2 of the applicant, which is incorporated by reference herein in its entirety.

The actual curing step, i.e., the gelation, may for example be done by contacting oil droplets containing a so-called gelation inducing agent, such as calcium ions, in a continuous aqueous phase with a so-called matrix forming agent, e.g., a polysaccharide, for example, sodium alginate. As soon as the oil droplets come in contact with the matrix forming agent, the matrix starts to form. In the example above, the calcium ions undergo an ion exchange reaction with the sodium alginate to form a water insoluble calcium alginate matrix. Such a matrix may for example form the shell of a capsule, which encases an oil core. Typically, the gelation reaction may be performed in a batch reactor. For example, oil droplets comprising Ca²⁺ as dispersed phase in an aqueous continuous phase are guided into a batch reactor comprising an aqueous solution of sodium alginate to induce capsule gelling. In alternative embodiments, the curing step may comprise the cooling of oil, for example wax, droplets from a temperature at which the oil, for example the wax, is liquid to a temperature at which it solidifies.

A disadvantage of such a process is however that the aqueous solutions of matrix forming agents, such as an aqueous sodium alginate or carrageenan solution, are typically prone to gel by themselves if they are not constantly kept in motion. Furthermore, ensuring homogeneity is often difficult to achieve, as the first droplets entering the batch reactor are in the example mentioned above exposed to a higher concentration of sodium alginate than the subsequent capsules. In addition, the first droplets are exposed for a longer time period to the sodium alginate and thus their shell will be thicker than that of subsequent droplets, respectively the capsules produced therefrom. In embodiments, in which the curing step may comprise the cooling of oil, for example wax, a common problem is that the liquid and also the only yet partially solidified capsules are prone to adhere to each other and to any parts of a device. Therefore batch solidification is typically not suitable as the capsules adhere to the reactor walls and to each other. Furthermore, the not yet fully solidified capsules are very labile and their structural integrity may be damaged during such a batch process.

Quenching of the gelation process, i.e., suspending the gelation, is commonly done by filtering the content of the batch reactor over a sieve. However, such a process can be too harsh for fragile capsules having thin capsule shells. Those capsules may break during the sieving process. Furthermore, such a quenching process removes all liquid from the capsules and the capsules are then resting on each other in a dry state, which may lead to agglomeration and/or to capsules adhering to each other.

### SUMMARY

It is therefore a general object of the present invention to advance the state of the art in the field of capsule production, in particular of capsule gelling, and to advantageously overcome the problems of the prior art fully or partly.

In advantageous embodiments, a capsule gelation quenching unit and a method for suspending capsule gelation is provided which allows to better control the gelation process, for example the capsule size and/or shell thickness. In further advantageous embodiments, a capsule gelation quenching unit and a method for suspending capsule gelation is provided which allows to suspend gelation without destroying the capsules. In further advantageous embodiments, a capsule gelation quenching unit and a method for suspending capsule gelation is provided which can be done in a continuous manner and is thus more efficient than the quenching processes and devices known in the prior art.

The general object and advantageous embodiments are disclosed herein.

A first aspect of the invention relates to a capsule gelation quenching unit, which is configured to suspend capsule gelation. The capsule gelation quenching unit comprises a tubular column, which defines, respectively comprises, a longitudinally arranged dispersion channel. Such a longitudinally arranged dispersion channel is a channel which extends in the longitudinal direction of the tubular column and whose extension in the longitudinal direction, i.e., its length, is larger than its extension in the radial direction, i.e., its width, respectively diameter. The dispersion channel is configured for transporting a dispersion of gelled capsules in a continuous phase, for example an aqueous continuous phase, along the longitudinal direction of the tubular column through the tubular column. Thus, it is understood, that the dispersion channel typically has a dispersion channel inlet and a dispersion channel outlet. The tubular column further comprises a first mesh unit. The first mesh unit may typically comprise a filter element. The first mesh unit may be made from a textile material, a polymer material or a metal. The material of the second mesh unit may in some embodiments be a woven. Furthermore, the capsule gelation quenching unit comprises a cross-flow fluid inlet unit. The cross-flow fluid inlet unit is configured such that a cross-flow fluid can be introduced into the dispersion channel, for example via the dispersion channel inlet, in such a way that the introduced cross-flow fluid flows transversely, and for example perpendicularly, to the longitudinal direction of the tubular column. Thus, the cross-flow fluid inlet unit is configured such that a cross-flow fluid can be introduced into the dispersion channel such that the introduced cross-flow fluid flows transversely, for example perpendicularly, to the gelled capsules being transported through the tubular column. Furthermore, the cross-flow fluid inlet unit is configured such that the cross-flow fluid flows through the first mesh unit. This has the advantage that the cross-flow fluid may replace and/or remove the matrix-forming agent, for example the sodium alginate, being present in the continuous phase of the dispersion of gelled capsules which is introduced into the dispersion channel. Alternatively, in some embodiments, in which curing comprises cooling droplets, the cross-flow fluid may have a lower temperature than the continuous phase and thus result in a cooling and solidification of the droplets, for example capsules. The first mesh unit thereby avoids that the capsules are removed from the dispersion channel. Thus, the first mesh unit typically has a mesh with a mesh size which is smaller than the diameter of the gelled capsules. The advantage of providing a cross-flow fluid in this manner is that the cross-flow fluid flows radially, while the gelled capsules flow longitudinally through the dispersion channel. This allows for continuously and homogenously removing the matrix forming agent and thus significantly improves the control over suspending the gelation process. Furthermore, the gelation time of each capsule is equal to the gelation time of all other capsules, which increases the homogeneity of the capsules.

In some embodiments, the dispersion channel may be arranged radially between the first mesh unit und the cross-flow fluid inlet unit.

Directional indications as they are used herein are to be understood as follows: The tubular column, respectively the capsule gelation quenching unit, has a longitudinal direction and a radial direction. The longitudinal direction of the tubular column is perpendicular to the radial direction of the tubular column. The extension of the tubular column and of the dispersion channel along the longitudinal direction is the length of the tubular column, respectively the dispersion channel. The extension of the tubular column and of the dispersion channel along the radial direction is the width or diameter of the tubular column, respectively the dispersion channel.

In some embodiments, the first mesh unit extends longitudinally along the tubular column. Although this may be the case, this does not mean that the first mesh unit necessarily extends over the complete length of the tubular column, i.e., its extension in the longitudinal direction. Typically, however, the first mesh unit has a length, i.e., an extension in the longitudinal direction, which is larger than the diameter of the tubular column, i.e., its extension in the radial direction. Preferably, the ratio of length of the first mesh unit to the diameter of the tubular column is between 1:1 to 20:1, or between 5:1 to 15:1.

In certain embodiments, the first mesh unit radially circumferentially surrounds the dispersion channel. This has the advantage that the cross-flow fluid can flow in any radial direction through the first mesh unit.

The dispersion channel is typically a straight channel, i.e., a linearly extending channel.

In some embodiments, the tubular column comprises a column wall, such as an inner column wall and/or an outer column wall. Such a column wall may in some embodiments radially and circumferentially surround and/or define the dispersion channel. For example, the column wall, in particular the outer column wall, may be made of glass or metal.

The first mesh unit may in certain embodiments form a part of the column wall. In some embodiments, the first mesh unit is aligned with the rest of the column wall. Thus, there is typically no step between the first mesh unit and the remaining part of the column wall.

The cross-flow fluid inlet unit may typically comprise an inlet port through which the cross-flow fluid can be introduced into the cross-flow fluid inlet unit and an outlet port, such as multiple openings, through which the cross-flow fluid can be expelled from the cross-flow fluid inlet unit into the dispersion channel. The inlet port may for example be in fluid connection with the cross-flow fluid inlet of the base portion as described further below.

Typically, at least a portion of, or the complete, cross-flow fluid inlet unit is arranged inside the tubular column.

In some embodiments, the cross-flow fluid inlet unit may be force locked and/or form locked to the tubular column. For example, the cross-flow fluid inlet unit may be clamped towards the tubular column.

In some embodiments, the cross-flow fluid inlet unit comprises an inlet tube. The inlet tube may at least partially be arranged inside the tubular column. Typically, the inlet tube extends along the longitudinal direction of the tubular column, for example along more than 20%, or more than 50%, of the length of the tubular column. In some examples, the inlet tube may be a straight tube. The length of the inlet tube inside the tubular column may for example be from 100 mm to 1200 mm, or from 400 mm to 1000 mm.

In certain embodiments, the inlet tube is coaxial with the dispersion channel and/or with the tubular column. The inlet tube may in some embodiments extend in parallel to the tubular column and/or the dispersion channel.

In some embodiments, the inlet tube has multiple inlet openings which may be directed towards the first mesh unit. In certain embodiments, the multiple inlet openings are radially and longitudinally arranged along the inlet tube.

In some embodiments, the cross-flow fluid inlet unit comprises a second mesh unit which is configured to introduce the cross-flow fluid into the dispersion channel. It is understood that the first and second mesh unit are different and typically separate from each other. In certain embodiments, the second mesh unit is configured such that the cross-flow fluid is introduced transversely, for example perpendicularly, to the longitudinal direction of the tubular column, respectively the dispersion channel. In other words, the second mesh unit is configured such that the cross-flow fluid is radially introduced into the dispersion channel. Typically, the second mesh unit is arranged inside the tubular column. In some embodiments, the second mesh unit circumferentially surrounds, in some examples completely surrounds, the inlet tube.

The second mesh unit may be made from a textile material, a polymer material or a metal. The material of the second mesh unit may in particular be a woven. A woven material has been shown to be particularly mild, which is beneficial for relatively soft and/or labile capsules.

The second mesh unit and the first mesh unit are typically spaced apart from each other such that they define the dispersion channel between them. The dispersion channel, the first mesh unit and the second mesh unit are typically coaxially arranged to each other. The dispersion channel width is in such embodiments defined as the radial distance between the first mesh unit, and the second mesh unit. In certain embodiments, the dispersion channel width is 5 mm to 50 mm, or 10 mm to 20 mm.

In certain embodiments, the second mesh unit is configured such that the cross-flow fluid is introduced transversely, for example perpendicularly, to the flow direction of the gelled capsules in the dispersion channel.

In some embodiments, the second mesh unit and the first mesh unit are aligned with each other, i.e., fluid being introduced radially from the second mesh unit into the dispersion channel is directly guided, i.e., linearly and radially, towards the first mesh unit.

In some embodiments, the tubular column, the first mesh unit, the second mesh unit and/or the inlet tube have the shape of a cylinder. Furthermore, also the dispersion channel may have the shape of a cylinder. If both the tubular column and the inlet tube of the cross-flow inlet unit have a cylindrical shape, the cylinder jackets extend typically essentially in parallel to each other.

In some embodiments, the second mesh unit extends longitudinally along the tubular column. Although this may be the case, this does not necessarily mean that the second mesh unit extends over the complete length of the tubular column, i.e., its extension in the longitudinal direction.

Typically, however, the second mesh unit has a length, i.e., an extension in the longitudinal direction, which is larger than the diameter of the tubular column, i.e., its extension in the radial direction. In some embodiments, the ratio of length of the second mesh unit to the diameter of the tubular column is 1:1 to 1:20, or 1:1 to 1:15.

The first mesh unit and/or the second mesh unit may have a length which is 80% to 100%, or 90% to 100%, of the length of the tubular column, respectively of the dispersion channel.

In some embodiments, the capsule gelation quenching unit further comprises a stirring device. Such a stirring device typically comprises one or more stirring elements which are configured to provide a radial mixing of the gelled capsules in the dispersion channel. The stirring device and the stirring elements are typically at least partially arranged inside the dispersion channel. Such a stirring device allows to radially move the gelled capsules and thereby avoids clogging of the first and/or the second mesh unit and also agglomeration of capsules.

In certain embodiments, the one or more stirring elements are each longitudinally arranged inside the tubular column, for example inside the dispersion channel, and are each rotatable around a longitudinal axis of the tubular column. Longitudinally arranged stirring elements are elongated along the longitudinal axis, i.e., in the axial direction of the tubular column, that is, in contrast to a radially arranged element which would be elongated along the radial direction. Typically, the extension of each stirring element in the longitudinal or axial direction of the tubular column is larger than the extension in the radial direction of the tubular column, for example at least 10-fold, or at least 50-fold, or larger. In some embodiments, each stirring element may extend essentially in parallel to the longitudinal axis of the tubular column. “Essentially in parallel” includes also stirring elements which are inclined by 10° or less, or 5° or less, with respect to the longitudinal axis of the tubular column. in some embodiments, the stirring elements are arranged in parallel to the longitudinal axis. In some embodiments, the stirring elements are rods, for example straight rods. For example, the stirring elements may be cylindrical rods.

In some embodiments in which the cross-flow fluid inlet unit comprises an inlet tube as described above, the one or more stirring elements may be arranged, respectively configured, such that they are rotatable around the inlet tube.

In some embodiments, the capsule gelation quenching unit further comprises a drive unit being configured for driving the stirring device, respectively for rotating the one or more stirring elements.

In some embodiments, the first mesh unit comprises a mesh having a mesh size of 100 μm to 3000 μm, or 300 μm to 1000 μm. In certain embodiments, the first mesh unit comprises a mesh having a mesh size of 400 μm to 600 μm.

In some embodiments, the second mesh unit has a mesh with a mesh size which is typically equal or smaller, or smaller, than the mesh size of the mesh of the first mesh unit. In some embodiments, the second mesh unit comprises a mesh having a mesh size of 20 μm to 500 μm, or 20 μm to 100 μm, or 80 μm to 100 μm.

In some embodiments, the ratio of the length of the dispersion channel and the diameter of the dispersion channel is 1:1 to 20:1, or 5:1 to 15:1, or 15:1 to 1:5.

In some embodiments, the capsule gelation quenching unit further comprises a base portion and/or a top portion. The base portion comprises a dispersion inlet for introducing a dispersion of gelled capsules in a continuous phase into the dispersion channel. Furthermore, the base portion comprises a first continuous phase outlet for removing parts of the continuous phase from the dispersion channel. The base portion may also comprise a cross-flow fluid inlet for introducing the cross-flow fluid into the cross-flow fluid inlet unit. The cross-flow fluid inlet may for example be in fluid connection with the inlet tube. The top portion comprises a dispersion outlet for removing a dispersion of gelled capsules in the cross-flow fluid from the dispersion channel. It is understood that this dispersion may also comprise a certain amount of the continuous phase in which the capsules have been introduced into the dispersion channel. However, in general the relative amount of the continuous phase is reduced as compared to the dispersion having been introduced into the dispersion channel via the dispersion inlet as it is at least partially replaced by the cross-flow fluid. Furthermore, the top portion comprises a second continuous phase outlet for removing parts of the continuous phase from the dispersion channel. Optionally, the top portion may comprise an additional support inlet being in fluid connection with the dispersion channel. Such a support inlet may be used also for removing a dispersion of gelled capsules in the cross-flow fluid from the dispersion channel or also for rinsing or cleaning of the capsule gelation quenching unit.

In some embodiments, the ratio of the open area of the cross-flow fluid inlet and the open area of the first and/or second continuous phase outlet is 2:1 to 1:6, or 2:1 to 1:4, or 1:1 to 1:4.

In some embodiments, the ratio of the open area of the cross-flow fluid inlet and the open area of the dispersion outlet is 0.5:1 to 5:1, or 2:1 to 4:1.

In some embodiments, the capsule gelation quenching unit further comprises one or more collecting ducts for collecting the continuous phase which is being replaced by the cross-flow fluid. In some embodiments, one collecting duct may be fluidic connected to the first continuous phase outlet of the base portion and one collecting duct may be fluidic connected the second continuous phase outlet of the top portion. In some embodiments, the collecting ducts may be tubes, such as straight tubes. For example, the tubes may be cylindrical. The collecting ducts are typically arranged inside the tubular column. Furthermore, the collecting ducts may longitudinally extend inside the tubular column, for example along the entire length of the tubular column. Typically, the collecting ducts each have one or more collecting openings being configured for providing a fluidic connection between the dispersion channel and the inside of each collecting duct.

It is understood that the tubular column is typically arranged between the top portion and the base portion. In other words, the tubular column is sandwiched between the top portion and the base portion of the capsule gelation quenching unit.

A second aspect of the invention relates to a capsule production device, which comprises a capsule gelation quenching unit according to any of the embodiments described herein, for example with respect to the first aspect, and which comprises an emulsification device. The emulsification device is configured for generating the dispersed phase. The capsule production device further comprises a gelation device for gelling capsules. The gelation device comprises a tubular gelation column, a dispersed phase inlet, a continuous phase inlet and an outlet. The dispersed phase inlet is fluidly connected with the emulsification device to introduce the generated dispersed phase into the gelation column. The gelation column outlet is fluidly connected with the dispersion channel of the capsule gelation quenching unit to introduce the gelled capsules into the dispersion channel. Thus, the emulsification device is arranged upstream of the gelation device and the capsule gelation quenching unit is arranged downstream of the gelation device.

The emulsification device may for example be a device as it is disclosed in WO 2021 037 999 A2 of the applicant, for example in the independent claim and the dependent claims. In particular, the emulsification device may be a device for generating a dispersion of a first phase in a second phase, the emulsification device comprising a first inlet for supplying a first phase, which opens into a first chamber, a second inlet for supplying a second phase, opening into a second chamber and a dispersion outlet for collecting the dispersion. Furthermore, the emulsification device comprises a membrane, which separates the first chamber and the second chamber and which comprises a first side facing the first chamber and a second side facing the second chamber. The membrane comprises multiple channels extending from the first side to the second side, providing a fluidic connection between the first chamber and the second chamber. Each channel comprises a channel inlet arranged on the first side and a channel outlet arranged on the second side. The first chamber may optionally be configured such that a flow rate of the first phase through all of the individual channels is essentially equal. Such an emulsification device may for example be fluidic connected via its dispersion outlet to the first fluid inlet of the bottom portion of the gelation device.

In some embodiments, the tubular gelation column of the gelation device has a longitudinal axis which extends along an axial direction of the tubular gelation column. Typically, the axial direction is perpendicular to the radial direction of the tubular gelation column. The gelation device further comprises a bottom portion and a head portion. Typically, the tubular gelation column is arranged between the bottom portion and the head portion. The bottom portion comprises a first fluid inlet being the dispersed phase inlet of the gelation device. The first fluid inlet is configured for introducing a dispersed phase into the tubular gelation column. Additionally, the bottom portion comprises another, second fluid inlet being the continuous phase inlet of the gelation device. The second fluid inlet is configured for introducing a continuous phase into the tubular gelation column. The head portion comprises a fluid outlet, being the outlet of the gelation device. The fluid outlet is configured for removing gelled capsules from the tubular gelation column. The gelled capsules are typically a dispersion in the continuous phase which is introduced into the tubular gelation column via the second fluid inlet. The gelation device further comprises a stirring device which is arranged inside the tubular gelation column. The stirring device comprises one or more stirring elements, which are each longitudinally arranged inside the tubular gelation column and which are each rotatable around the longitudinal axis of the tubular gelation column. Each stirring element is configured to provide for a radial mixing of the dispersed phase and the continuous phase, i.e., the dispersed phase being introducible via the first fluid inlet and the continuous phase being introducible via the second fluid inlet. Optionally, each stirring element is configured to essentially avoid axial mixing of the dispersed phase and the continuous phase.

It is understood that the longitudinal axis of the tubular gelation column is arranged in the center of the tubular gelation column. In some examples, the longitudinal axis has in any radial direction the same distance to the gelation column walls.

Longitudinally arranged stirring elements are elongated along the longitudinal axis, i.e., in the axial direction of the tubular gelation column, that is, in contrast to a radially arranged element which would be elongated along the radial direction. Typically, the extension of each stirring element in the axial direction of the tubular gelation column is larger than the extension in the radial direction of the tubular gelation column, for example at least 10-fold, or at least 50-fold, or larger. In some embodiments, each stirring element may extend essentially in parallel to the longitudinal axis of the tubular gelation column. “Essentially in parallel” includes also stirring elements which are inclined by 10° or lessor 5° or less, with respect to the longitudinal axis of the tubular gelation column. Preferably, the stirring elements are arranged in parallel to the longitudinal axis.

Each stirring element may extend through the tubular gelation column, for example in the axial direction through at least 50%, or through at least 75%, or through at least 85%, or through at least 90%, or completely through, the tubular gelation column.

By employing one or more stirring elements as described, the dispersed phase comprising droplets and/or capsules, for example growing or gelling capsules, are constantly kept in motion, which prevents agglomeration. Furthermore, as the dispersed phase is continuously guided through the gelation column in its axial direction in presence of the continuous phase without axial mixing, the residence time of the capsules is constant over each capsule, which ensures a uniform capsule size and quality. Additionally, employing longitudinally arranged stirring elements allows for providing a constant mixing over the gelation column, which ensure uniformity of the capsules and also helps to prevent blockage of the gelation column.

The tubular gelation column is in some embodiments cylindrical. In some embodiments, the tubular gelation column may define a cylindrical chamber. It is understood that the tubular gelation column has a head opening and a bottom opening. Typically, the bottom portion of the gelling device is attached to the bottom opening of the tubular gelation column and the head portion of the gelling device is attached to the head opening of the tubular gelation column. The tubular gelation column has gelation column walls, which define the gelation column chamber, i.e., the chamber in which the stirring device is arranged. In some embodiments, the tubular gelation column may essentially be rotationally symmetric with respect to its longitudinal axis.

In certain embodiments, each stirring element is configured such that it has a rotation path, for example a circular rotation path or an epicycloid rotation path, when it rotates around the longitudinal axis of the tubular gelation column. In specific embodiments, each rotation path of each stirring element is concentric with the gelation column walls.

In some embodiments, the tubular gelation column, the one or more stirring elements, the head portion and/or the bottom portion comprise, or consist of, metal, for example steel.

In some embodiments, the length, i.e., the extension of the tubular gelation column in the axial direction, to width, respectively the diameter, of the tubular gelation column is at least 5:1, or at least 10:1. Thus, the flow behavior within the tubular gelation column typically resembles a pipe flow. In particular, the length of the tubular gelation column may in some embodiments be at least 0.50 m, or at least 1 m, or at least 1.2 m. In some embodiments, the width, respectively the diameter of the tubular gelation column is 5 cm to 50 cm, or 10 cm to 30 cm.

In some embodiments, the stirring device, and for example the one or more stirring elements, are configured such that a radial vortex is generated when mixing the dispersed phase and the continuous phase.

In some embodiments, the stirring elements are rods, for example straight rods. For example, the stirring elements may be cylindrical rods. It is also possible that the rods have a helical shape, i.e., they extend along the axial direction in a helical manner. In other embodiments, the stirring elements are plates.

In some embodiments, the capsule production device further comprises a dosing unit being configured for adjusting and controlling the pressure, for example the pressure in the emulsification device, respectively the pressure at which the dispersed phase is generated in the emulsification device.

In certain embodiments, the dosing unit comprises a dosing unit inlet and a dosing unit outlet, wherein the dosing unit outlet is arranged downstream of the dosing unit inlet. Between the dosing unit inlet and the dosing unit outlet may be arranged a particle filter being configured for filtering a fluid, a gear pump, a pressure sensor and a flowmeter. In some embodiments, the particle filter is arranged downstream of the dosing unit inlet, the gear pump is arranged downstream of the particle filter, the pressure sensor is arranged downstream of the gear pump and the flowmeter is arranged downstream of the pressure sensor. Thus, in such embodiments, the order of arrangement from the dosing unit inlet to the dosing unit outlet is particle filter, then gear pump, then pressure sensor, then flow meter. Using a gear pump has the advantage that such pumps are pulsation free or at least less prone to pulsations than other pumps, for example at low pressures. This avoids pulsations at the channels of the emulsification device, which may fluidically connect the first chamber and the second chamber as described herein.

In some embodiments, the dosing unit inlet, the particle filter, the gear pump, the pressure sensor, the flow meter, optionally the control valve, and the dosing unit outlet are linearly arranged one after another. Thus, in such embodiments, the dosing unit inlet and the dosing unit outlet are arranged at opposite ends of the dosing unit, which simplifies degassing and further reduced the dead volume of the unit.

In some embodiments, the flowmeter is a calibration-free flowmeter, which allows for an operation of the flowmeter which is independent of the nature of the fluid flowing there through.

In some embodiments, the dosing unit further comprises a control valve. The control valve may be an on-off valve. Typically, the control valve may be arranged downstream of the flowmeter and upstream of the dosing unit outlet.

In some embodiments, the pressure sensor has a resolution of 16 bit. In some embodiments, the accuracy is +0.15 mbar.

In certain embodiments, the particle filter is configured for filtering solid particles having a particle size of 10 μm to 60 μm, or 40 μm to 60 μm or more. In some embodiments, the particle filter has a mesh size of 10 μm to 60 μm, or 40 μm to 60 μm.

It is understood that the dosing unit inlet and the dosing unit outlet are in fluid connection with each other, for example by a dosing unit tube. Furthermore, it is understood that also the particle filter, the gear pump, the pressure sensor, the flowmeter and optionally the control valve are in fluid connection with the dosing unit inlet and the dosing unit outlet, e.g., by the dosing unit tube.

A third aspect of the invention relates to a method for suspending, i.e., stopping, capsule gelation. The method comprises the steps:
Providing a capsule gelation quenching unit according to any of the embodiments as described herein, for example with respect to the first aspect;
Guiding a dispersion of gelled capsules in a continuous phase through the tubular column of the capsule gelation quenching unit via the dispersion channel. The continuous phase comprises a first liquid and a matrix-forming agent.
Introducing a cross-flow fluid via the cross-flow fluid inlet unit into the dispersion channel such that the introduced cross-flow fluid flows transversely, for example perpendicularly, to the longitudinal direction of the tubular column. Cross-flow fluid is introduced via the cross-flow fluid inlet unit into the dispersion channel such that that the introduced cross-flow fluid flows transversely, for example perpendicularly, to the gelled capsules being transported through the tubular column. It is understood that during this step, the first liquid and the cross-flow fluid contact each other.
Removing the cross-flow fluid from the dispersion channel via the first mesh unit of the tubular column.
Optionally removing the gelled capsules from the capsule gelation quenching unit.

Typically, the first liquid and the cross-flow fluid are miscible with each other, i.e., no phase separation is observed at room temperature (23° C.) and normal pressure (1 atm.) and they fully dissolve in each other at any concentration forming a homogeneous mixture. In some examples, the first fluid and the second fluid are of the same phase, i.e., they may both be aqueous, e.g., water.

It is understood that during removal of the cross-flow fluid from the dispersion channel via the first mesh unit of the tubular column, the amount of matrix-forming agent in the continuous phase is reduced, and in some embodiments the matrix-forming agent is completely removed from the continuous phase.

In some embodiments, the stirring device and in particular the one or more stirring elements of the capsule gelation quenching unit are operated at a stirring speed of 50 rpm to 1000 rpm, or 200 rpm to 400 rpm.

In some embodiments, the cross-flow fluid being introduced via the cross-flow fluid inlet unit into the dispersion channel has a temperature which is different, or lower, such as at least 5° C. or at least 10° C. lower, than the temperature of continuous phase, respectively the first liquid.

Typically, the matrix-forming agent is configured to form a matrix. A matrix is typically solid, for example a solid polymer network. In some embodiments, the matrix may comprise a polysaccharide, for example an ionic polysaccharide complex. In some embodiments, the matrix, for example the polysaccharide or the ionic polysaccharide complex, is water insoluble. For example, the matrix may comprise an alkaline earth metal or alkaline metal complex of a polysaccharide, such as calcium alginate, calcium carrageenan, potassium alginate or potassium carrageenan.

In some embodiments, the matrix-forming agent is a polysaccharide or suitable salt thereof. A suitable salt is a salt form which can be completely dissolved in water. Typically, polysaccharide salts may be composed of an anionic polysaccharide component and a suitable counter cation. Suitable polysaccharides are selected from chitosan, cellulose, alginate, particularly sodium alginate, carrageenan, agar, agarose, pectins, gellan, starch, and the like. Preferred polysaccharides are alginate, for example sodium alginate, chitosan, carrageenan and cellulose, preferably alginate, preferably sodium alginate, chitosan. In some embodiments, the polysaccharides may be solubilized by adjusting the pH, for example by basifying the pH of the aqueous shell-forming solution.

The matrix of the capsules is formed by a gelation-inducing agent. The gelation-inducing agent and the matrix-forming agent are configured such that they are capable of undergoing a chemical reaction with each other to form a water insoluble matrix, for example a matrix shell of a capsule. These may for example be configured to undergo a complexation reaction, an ion-exchange reaction or an interphase limited polymerization reaction. The gelation-inducing agent may be an inorganic salt, for example an alkaline earth metal salt, such as an alkaline earth metal halide, an alkaline earth metal pseudohalide, an alkaline earth metal carboxylate or an alkaline earth metal nitrate, or an alkaline metal halide, an alkaline metal pseudohalide, an alkaline metal carboxylate or an alkaline metal nitrate. In some embodiments in which the gelation-inducing agent is an inorganic salt, as outlined above, the reaction in step e. between the gelation-inducing agent and the matrix-forming agent is an ion exchange reaction, i.e., an ionotropic gelation. Thus, the inorganic salt (and vice versa the matrix-forming agent) are selected such that its reaction with the matrix-forming agent results in a water insoluble reaction product. Some examples of salts, especially for polysaccharides, may thus be K, Mg, Sr or Ca salts. The skilled person understands the term “pseudohalide”, which is also referred to as “pseudohalogenide” as polyatomic analogues of halogens, whose chemistry resembles that of true halogens. Non-limiting examples include cyanide, isocyanide, cyanate, isocyanate, methylsulfonyl and triflyl. Non limiting examples of carboxylates are acetate, formate, lactate, oxalate, butyrate, succinate and the like. The gelation-inducing agent is typically selected such that it is completely soluble in water at room temperature, i.e., has a solubility in water of >10 g/100 mL, or of >20 g/100 mL, or of >50 g/100 mL. Non-limiting examples of suitable gelation-inducing agents are: CaCl₂, CaF₂, Calcium lactate, MgCl₂, Sr(OAc)₂.

In some embodiments, the resident time of each capsule inside the dispersion channel of the capsule gelation quenching unit is 20 s to 400 s, or 60 s to 120 s, or 80 s to 100 s.

In some embodiments, the pressure with which the dispersion of capsules is introduced into the dispersion channel is an overpressure with respect to atmospheric pressure of 0.2 bar to 2 bar, or 0.7 bar to 1.2 bar.

In some embodiments, the pressure with which the cross-flow fluid is introduced into the dispersion channel is an overpressure with respect to atmospheric pressure of 0.5 bar to 2.5 bar, or 1 bar to 1.8 bar.

A fourth aspect of the invention relates to the use of a capsule gelation quenching unit according to any of the embodiments as described herein, for example respect to the first aspect, for suspending gelation of capsules being dispersed in a continuous phase comprising a matrix-forming agent, such as a gellant.

A fifth aspect of the invention relates to the use of a capsule production device according to any of the embodiments as described herein, for example respect to the second aspect, for producing capsules, in particular for producing capsules having a matrix shell encasing a liquid core, particularly liquid oil, core.

A sixth aspect of the invention relates to a method for refining capsules. The method comprises the steps:
Providing a capsule gelation quenching unit according to any of the embodiments as described herein, for example respect to the first aspect;
Guiding a dispersion of capsules in a continuous phase through the tubular column of the capsule gelation quenching unit via the dispersion channel. The continuous phase comprises a first liquid and an amount of an impurity having a smaller particle size than the capsules, for example than each of the capsules. The particle size may for example be determined by sieve analysis or by dynamic light scattering.
Introducing a cross-flow fluid via the cross-flow fluid inlet unit into the dispersion channel such that the introduced cross-flow fluid flows transversely, for example perpendicularly, to the longitudinal direction of the tubular column. In some examples, cross-flow fluid is introduced via the cross-flow fluid inlet unit into the dispersion channel such that that the introduced cross-flow fluid flows transversely for example perpendicularly, to the gelled capsules being transported through the tubular column. It is understood that during this step, the first liquid and the cross-flow fluid contact each other.
Removing the cross-flow fluid from the dispersion channel via the first mesh unit of the tubular column.
Optionally removing the gelled capsules from the capsule gelation quenching unit.

The impurity may be soluble in the first liquid and also in the cross-flow fluid. In some embodiments, the impurity may for example be a surfactant, such as polyvinyl alcohol.

In typical embodiments, the impurity is dissolved in the continuous phase. It is understood that if the impurity is dissolved in the continuous phase that then the term “particle size” refers for example to the size of the dissolved molecule.

It is understood that in the embodiments of the sixth aspect of the invention, the capsule gelation quenching unit may be considered and termed as a capsule refining unit.

Preferably during removing the cross-flow fluid from the dispersion channel via the first mesh unit of the tubular column, also the impurity is at least partially or fully removed from the continuous phase.

Typically, the first liquid and the cross-flow fluid are miscible with each other, i.e., no phase separation is observed at room temperature (23° C.) and normal pressure (1 atm.) and they fully dissolve in each other at any concentration forming a homogeneous mixture. In particular, the first fluid and the second fluid are of the same phase, i.e., they may both be aqueous, e.g., water.

In some embodiments, the stirring device and for example the one or more stirring elements of the capsule gelation quenching unit are operated at a stirring speed of 50 rpm to 1000 rpm, or 200 rpm to 400 rpm.

In some embodiments, the resident time of each capsule inside the dispersion channel of the capsule gelation quenching unit is 20 s to 400 s, or 60 s to 120 s, or 80 s to 100 s.

In some embodiments, the pressure with which the dispersion of capsules is introduced into the dispersion channel is an overpressure with respect to atmospheric pressure of 0.2 bar to 2 bar, or 0.7 bar to 1.2 bar.

In some embodiments, the pressure with which the cross-flow fluid is introduced into the dispersion channel is an overpressure with respect to atmospheric pressure of 0.5 bar to 2.5 bar, or 1 bar to 1.8 bar.

A seventh aspect of the invention relates to the use of a capsule gelation quenching unit according to any of the embodiments as described herein, for example with respect to the first aspect, for refining capsules being dispersed in a continuous phase. In some embodiments, the continuous phase comprises a first liquid and an impurity having a smaller particle size than the capsules. The particle size may for example be determined by sieve analysis or by dynamic light scattering. The impurity can be removed and thereby the capsules are refined, as described with respect to the embodiments of the method of the sixth aspect of the invention.

### BRIEF DESCRIPTION OF THE DRAWINGS

The herein described invention will be more fully understood from the detailed description given herein below and the accompanying drawings which should not be considered limiting to the invention described in the appended claims. The drawings are showing:

FIG. 1a a capsule gelation quenching unit according to an embodiment of the invention;

FIG. 1b a sectional view of the capsule gelation quenching unit of FIG. 1a along D-D

FIG. 2a a sectional view of a capsule gelation quenching unit according to another embodiment of the invention;

FIG. 2b an enlarged view of detail H of the capsule gelation quenching unit of FIG. 2a;

FIG. 2c an enlarged view of detail F of the capsule gelation quenching unit of FIG. 2a;

FIG. 3a a sectional view of a base portion of the capsule gelation quenching unit of FIG. 1a;

FIG. 3b a sectional view of a top portion of the capsule gelation quenching unit of FIG. 1a;

FIG. 4 an exploded view of the capsule gelation quenching unit of FIG. 1a;

FIG. 5 a partially sectioned view of the capsule gelation quenching unit of FIG. 1a;

FIG. 6 a perspective view of a dosing unit according to an aspect of the invention;

FIG. 7 a schematic view of a capsule production device according to an embodiment of the invention.

### DETAILED DESCRIPTION

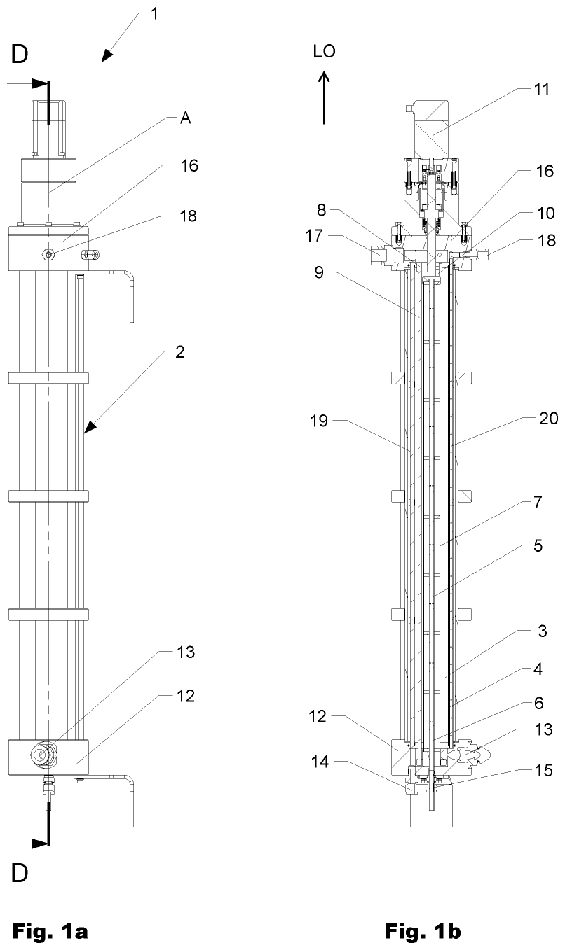

FIG. 1a depicts capsule gelation quenching unit 1 according to an embodiment of the invention, which comprises tubular column 2 being arranged between top portion 16 and base portion 12. Rotational axis A extends along the longitudinal direction LO.

FIG. 1b, shows a sectional view of capsule gelation quenching unit 1 of FIG. 1a along D-D. As can be seen, tubular column 2 comprises dispersion channel 3, which extends through the column, i.e., which is longitudinally arranged. Dispersion channel 3 is thus configured to transport a dispersion of gelled capsules in a continuous phase along a longitudinal direction LO of tubular column 2 through the tubular column. Tubular column 2 further comprises first mesh unit 4, which delimits dispersion channel 3. First mesh unit 4 completely circumferentially surrounds dispersion channel 3. Furthermore, capsule gelation quenching unit 1 comprises cross-flow fluid inlet unit 5 which is generally configured to introduce a cross-flow fluid into dispersion channel 3 such that the cross-flow fluid flows transversely, or perpendicularly, to the longitudinal direction LO of tubular column 2. Furthermore, cross-flow fluid inlet unit 5 is configured such that the cross-flow fluid flows through first mesh unit 4, i.e., it penetrates through the mesh of mesh unit 4. In the embodiment shown, fluid can flow radially over the entire length, i.e., the extension along the longitudinal direction, of the cross-flow fluid inlet unit 5 in and through dispersion channel 3, thereby exchanging the introduced continuous phase at least partially, or completely, by cross-flow fluid. The capsules however are maintained within dispersion channel 3 as these have a larger particle size, respectively mesh size, than the mesh size of first mesh unit 4. The skilled person is aware that the particle size may for example be determined by sieving. Therefore, during the transport of the capsules trough tubular column 2 via dispersion channel 3, the continuous phase which may for example comprise a gellant, is exchanged by cross-flow fluid, thereby ceasing the gelation process in a continuous and efficient manner. In order to avoid clogging and ensure mixing, capsule gelation quenching unit 1 further comprises stirring device 8 with three longitudinally extending stirring elements 9 and 10 (only two are visible). These stirring elements are in general rotatable around a common rotational axis, such as longitudinal axis A, and thus provide for a radial mixing. Capsule gelation quenching unit 1 further comprises drive unit 11, which drives the stirring device 8, i.e., which rotates the stirring elements 9 and 10 around the longitudinal axis A.

Base portion 12 comprises dispersion inlet 13 being in fluid communication with dispersion channel 3, through which the dispersion of capsules in a continuous phase can be fed into dispersion channel 3. Furthermore, base portion 12 comprises cross-flow fluid inlet 15 which is in fluid communication with cross-flow fluid inlet unit 5 and through which cross-flow fluid can be fed into cross-flow fluid inlet unit 5. In general, in the radial direction, the cross-flow fluid inlet unit 5 is arranged first, followed by dispersion channel 3, followed by first mesh unit 4. Base portion 12 also comprises first continuous phase outlet 18, which is configured for removing at least a part of the continuous phase having been introduced into dispersion channel 3 from the dispersion channel. In the embodiment shown, first continuous phase outlet 18 is in fluid communication with collecting duct 19 which is longitudinally arranged inside tubular column 2. Such collecting ducts may in this and any other embodiment be arranged radially outward of the first mesh unit 4.

Top portion 16 comprises dispersion outlet 17 through which the quenched capsule dispersion of capsules in the cross-flow fluid and potentially remaining parts of the introduced continuous phase can be removed from dispersion channel 3. In addition, top portion 16 comprises second continuous phase outlet 18 through which parts of the continuous phase can be removed from dispersion channel 3. Second continuous phase outlet 18 is in fluid communication with a second collecting duct 20 which is also longitudinally arranged inside tubular column 2. As can be seen, collecting duct 20 comprises multiple collecting openings which provide a fluid connection between the inside of collecting duct 20 and dispersion channel 3.

Cross-flow fluid inlet unit 5 comprises an inlet tube 6 which may in general extend longitudinally and which may at least partially be arranged inside tubular column 2. Inlet tube 6 comprises multiple inlet openings which are directed towards first mesh unit 4. Cross-flow fluid inlet unit 5 further comprises second mesh unit 7 through which cross-flow fluid can be introduced into dispersion channel 3. Second mesh unit 7 extends longitudinally inside tubular column 2 and completely surrounds inlet tube 6. Inlet tube 6, second mesh unit 7, dispersion channel 3, first mesh unit 4 and tubular column 2 all are coaxial to each other and may in general be in the radial direction arranged in that order. The dispersion channel 3 is defined, respectively delimited by the first mesh unit 4 and the second mesh unit 7.

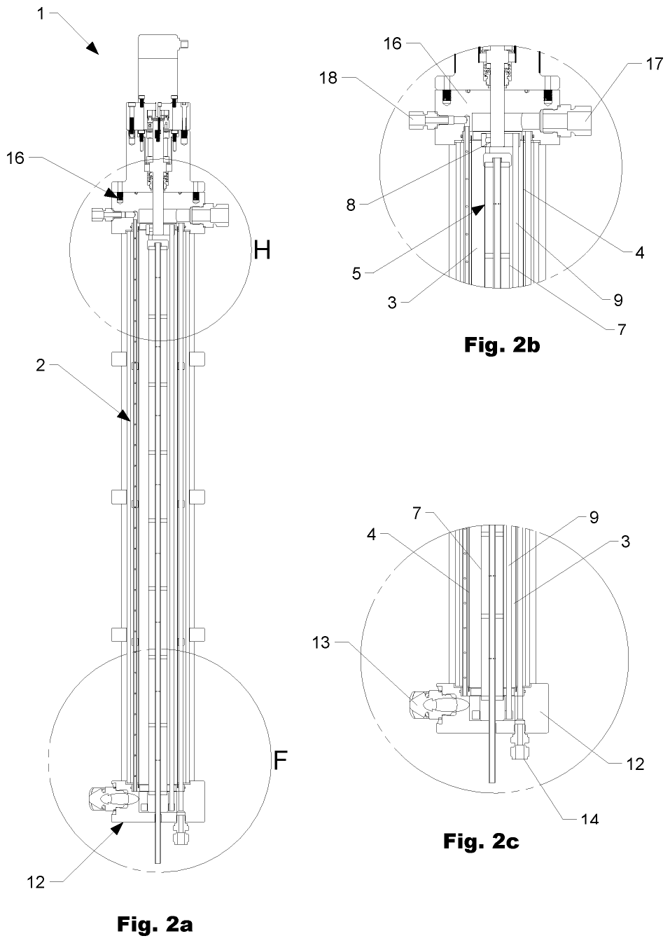

FIG. 2a shows a cross sectional view of a capsule gelation quenching unit 1 according to another embodiment of the invention. Details F and H, depicted in FIGS. 2b and 2c, show that dispersion channel 3 is formed by first mesh unit 4 and second mesh unit 7 which are spaced apart from each other.

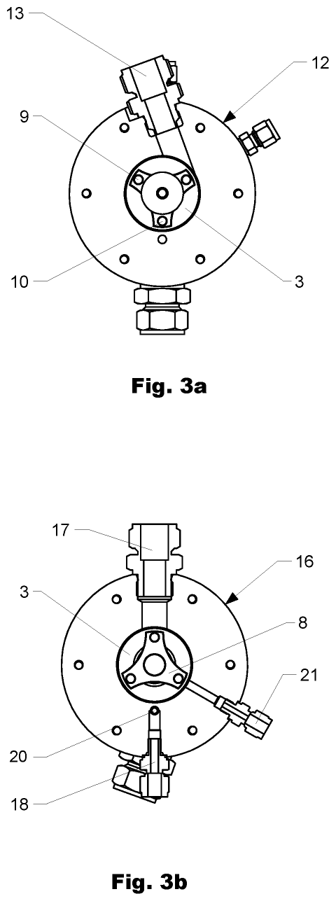

FIG. 3a shows a cross sectional view of base portion 12 of a capsule gelation quenching unit 1. As can be seen, dispersion inlet 13 is in fluid communication with dispersion channel 3. In this and in any other embodiment, the dispersion inlet may be configured such that a dispersion of gelled capsules in a continuous phase can be tangentially introduced into the dispersion channel. Furthermore, three stirring elements 9, 10 (only two are referenced for clarity purposes) are visible which are arranged within dispersion channel 3.

FIG. 3b shows a cross sectional view of top portion 16 of a capsule gelation quenching unit 1. Stirring device 8 is visible, whose stirring elements extend into dispersion channel 3. Dispersion channel 3 is in fluid communication with dispersion outlet 17 for removing a dispersion of gelled capsules in the cross-flow fluid from dispersion channel 3 and second continuous phase outlet 18 of top portion 16 is in fluid communication with second collecting duct 20. Furthermore, top portion 16 comprises additional support inlet 21 for cleaning and/or washing, which is also in fluid connection with dispersion channel 3.

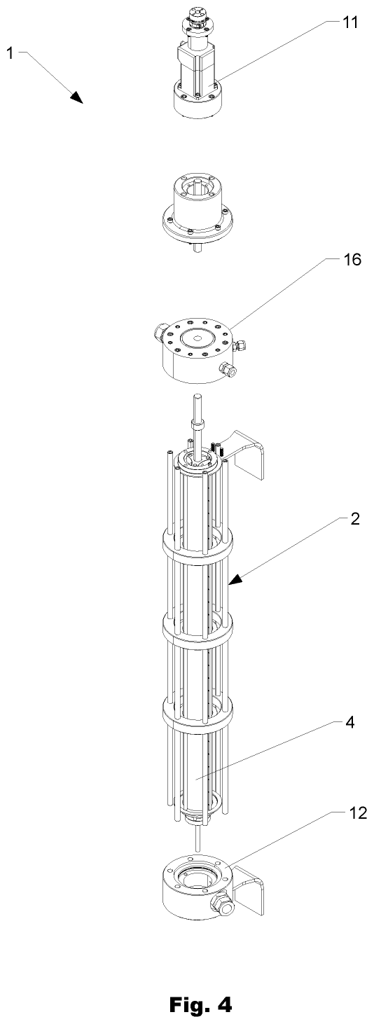

FIG. 4 shows an exploded view of capsule gelation quenching unit 1 shown in FIG. 1a with tubular column 2, whose outer wall has been removed to illustrate the inside of tubular column 2 and to show first mesh unit 4 which circumferentially completely surrounds the inlet tube as well as the dispersion channel and the second mesh unit.

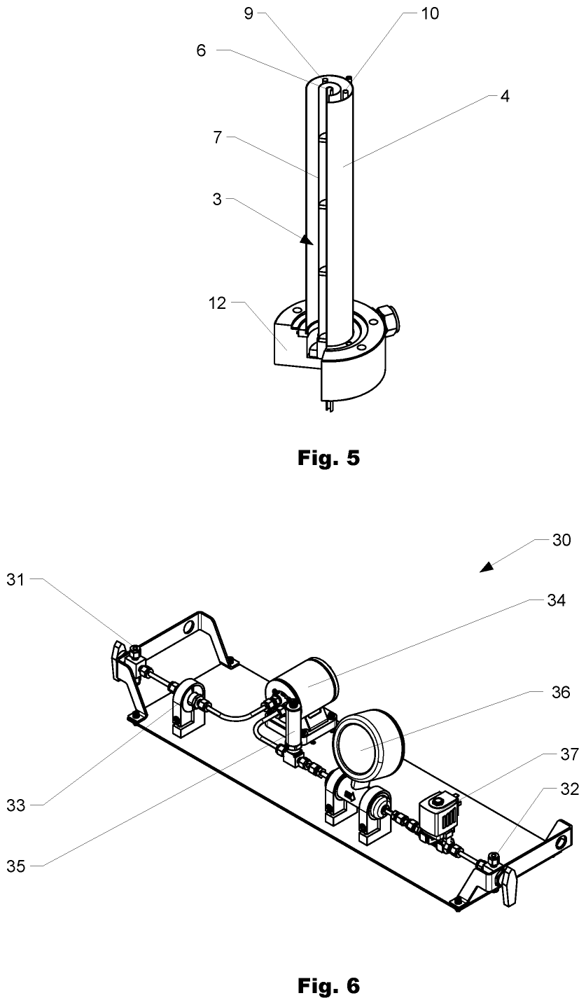

FIG. 5 shows a perspective partially sectioned view of only a part of a capsule gelation quenching unit. As in FIG. 4, the outer wall of the tubular column has been removed. It can be seen that dispersion channel 3 is arranged radially between first mesh unit 4 and second mesh unit 7. Furthermore, rod-like stirring elements 9 and 10 are arranged inside dispersion channel 3 and can rotate around inlet tube 6 and in general also around second mesh unit 7.

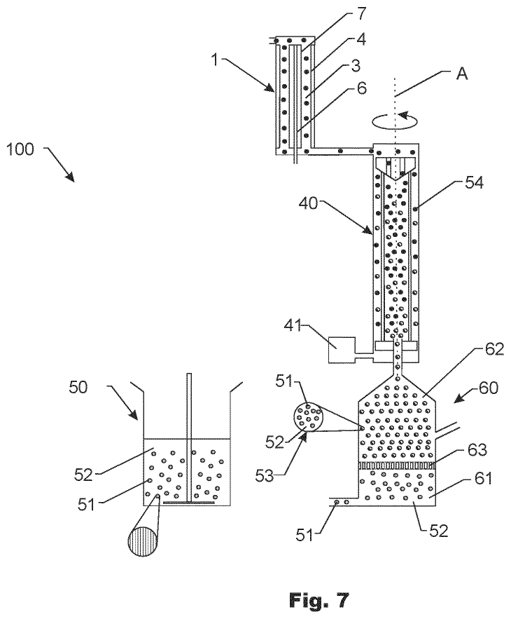

FIG. 6 shows dosing unit 30 as it can be used in a capsule production device 100 according to an embodiment of the invention. Dosing unit 30 comprises dosing unit inlet 31 and a dosing unit outlet 32 which are in fluid connection by a dosing unit tube. As can be seen, dosing unit outlet 32 is arranged downstream of dosing unit inlet 31. Between dosing unit inlet 31 and dosing unit outlet 32 is particle filter 33 being configured for filtering a fluid flowing through the dosing unit tube, gear pump 34, pressure sensor 35 and flowmeter 36. Furthermore, arranged downstream of flowmeter 36 and upstream of dosing unit outlet 32 is control valve 37. When being used in a capsule production device as described herein, then the dosing unit outlet is typically connected to the inlet of the first chamber 61 (see FIG. 7) of the emulsification device. Thus, the dosing unit may provide droplets 51 being dispersed in oil phase 52 (see FIG. 7) to the first chamber 61 of emulsification device 60.

FIG. 7 shows a capsule production device 100 comprising a capsule gelation quenching unit 1 as described in any of the embodiments herein, for example a device as depicted in FIG. 1a-c, an emulsification device 60, which is configured for generating the dispersed phase, and a gelation device 40 for gelling capsules. Gelation device 40 comprises a tubular gelation column, a dispersed phase inlet, a continuous phase inlet for introducing a continuous phase from continuous phase reservoir 41 and an outlet. The dispersed phase inlet is fluid connected with the emulsification device 60 to introduce the generated dispersed phase into the gelation column. The gelation column outlet is fluid connected with the dispersion channel of the capsule gelation quenching unit 1 to introduce the gelled capsules into the dispersion channel 3. Capsule production device 100 further comprises continuous phase reservoir 41 which is fluidic connected to the continuous phase inlet of gelation device 40. Capsules can for example be produced with such a device as follows:

In a first step, a core forming emulsion is generated by mixing a solution 51 comprising a gelation inducing agent, a surfactant and water with oil phase 52 (left side of the figure). This may for example be done with a stirrer. The figure on the left shows a vessel with droplets 51 and also an enlarged view of a selected droplet 51 of solution in the emulsion. The straight lines of the droplets represent droplets comprising water and dissolved therein the gelation inducing agent, for example an inorganic salt A⁺B⁻. Thus every droplet 51 shown is an aqueous solution of the gelation inducing-agent. The formed emulsion of the aqueous solution 51 of the gelation-inducing agent in oil phase 52 is then provided into first chamber 61 of emulsification device 60 via a corresponding inlet. Second chamber 62 of the emulsification device comprises a second aqueous solution comprising water and a surfactant. This second aqueous solution may be provided via the shown inclined inlet of the second chamber 62. As can be seen, first chamber 61 and second chamber 62 are fluidically connected by multiple channels 63. In the embodiment shown, the first chamber and the second chamber are separated by membrane whose first side faces towards the first chamber and whose second side faces towards the second chamber. Channels 63 extend from the first side towards the second side. In general, a suitable pressure is applied on core-forming emulsion in first chamber 61. The emulsion in first chamber 61 is then guided through channels 63. As the emulsion generally comprises as the major component the oil phase 52, a step emulsification takes place as the emulsion reaches the channel outlet opening into second chamber 52, thereby forming a dispersion of the core forming emulsion, i.e., monodisperse droplets 53 in the second aqueous phase. It should be noted that the sizes of the droplets are exaggerated for clarity purposes. Furthermore, the relative size of droplets 51 with respect to droplets 53 does not resemble the reality. Each monodisperse droplet 53 in second chamber 62 now comprises one or more droplets 51 being dispersed in oil phase 52, as it illustrated in the enlarged view of droplet 53. Thus the dispersion in second chamber 62 may be considered as a “water in oil in water emulsion”. This dispersion is provided via the dispersion outlet of emulsification device 60 into gelation device 40 via the dispersed phase inlet of the gelation device 40. A further continuous phase is provided from reservoir 41 via corresponding continuous phase inlet of the gelation device 40 into its tubular column. The dispersed phase coming from the emulsification device is then mixed with the continuous phase from reservoir 41, which is an aqueous shell forming solution comprising water and a water soluble and dissolved matrix-forming agent, for example sodium alginate. When the dispersion of the core forming emulsion, i.e., monodisperse droplets 53 in the second aqueous phase is mixed with the aqueous shell forming solution by rotating the stirring elements around longitudinal axis A of the tubular column (see arrow), the gelation-inducing agent, e.g. Ca²⁺ within droplets 53 diffuses towards the droplet surface and then chemically reacts at the interface with the matrix-forming agent to form a water insoluble matrix shell, which fully grows around each droplet thereby forming capsules 54 of a water insoluble matrix shell encasing an oil core. The gelled capsules are filled in black color, while the half-filled circles in gelation device 40 represent droplets 53 or currently still gelling capsules. These capsules then rise and are removed via the fluid outlet from gelation device 60. As the capsules are still present as a dispersion in a continuous phase comprising a matrix-forming agent, for example sodium alginate, the gelation inducing agent being still present in the capsules may still react. In order to quench this reaction, the dispersion is then fed into capsule gelation quenching unit 1. The dispersion is guided through the tubular column of capsule gelation quenching unit 1 via dispersion channel 3. Concomitantly, a cross-flow fluid is introduced via inlet tube 6 into dispersion channel 3 through second mesh unit 7. It then flows transversely, or perpendicularly, to the capsules and washes away the matrix-forming agent in the capsule dispersion, which is removed from dispersion channel 3 via first mesh unit 4. The quenched capsules rise and are then collected via the corresponding dispersion outlet of capsule gelation quenching unit 1.

1. A capsule gelation quenching unit for suspending capsule gelation, the capsule gelation quenching unit comprising:
a. a tubular column comprising a longitudinally arranged dispersion channel, wherein the dispersion channel is configured for transporting a dispersion of gelled capsules in a continuous phase along a longitudinal direction of the tubular column through the tubular column, and wherein the tubular column further comprises a first mesh unit;
b. a cross-flow fluid inlet unit, wherein the cross-flow fluid inlet unit is configured such that a cross-flow fluid can be introduced into the dispersion channel such that the introduced cross-flow fluid flows transversely to the longitudinal direction of the tubular column; and wherein the cross-flow fluid inlet unit is configured such that the cross-flow fluid flows through the first mesh unit.

2. The capsule gelation quenching unit according to claim 1, wherein the first mesh unit extends longitudinally along the tubular column.

3. The capsule gelation quenching unit according to claim 1, wherein the first mesh unit radially circumferentially surrounds the dispersion channel.

4. The capsule gelation quenching unit according to claim 1, wherein the cross-flow fluid inlet unit comprises an inlet tube, wherein the inlet tube is at least partially arranged inside the tubular column.

5. The capsule gelation quenching unit according to claim 1, wherein the cross-flow fluid inlet unit comprises a second mesh unit through which the cross-flow fluid can be introduced into the dispersion channel.

6. The capsule gelation quenching unit according to claim 5, wherein the dispersion channel is formed between the first mesh unit and the second mesh unit.

7. The capsule gelation quenching unit according to claim 4, wherein the tubular column and/or the inlet tube has the shape of a cylinder.

8. The capsule gelation quenching unit according to claim 1, further comprising a stirring device, wherein the stirring device is configured for providing a radial mixing of the dispersion of gelled capsules in the dispersion channel.

9. The capsule gelation quenching unit according to claim 8, wherein the stirring device comprises one or more stirring elements configured for providing the radial mixing.

10. The capsule gelation quenching unit according to claim 9, wherein the one or more stirring elements are each longitudinally arranged inside the tubular column, and are each rotatable around a longitudinal axis of the tubular column.

11. The capsule gelation quenching unit according to claim 1, further comprising a drive unit being configured for driving the stirring device.

12. The capsule gelation quenching unit according to claim 5, wherein the first mesh unit comprises a mesh having a mesh size of 100 μm to 3000 μm and/or wherein the second mesh unit comprises a mesh having a mesh size of 20 μm to 500 μm.

13. The capsule gelation quenching unit according to claim 1, wherein the capsule gelation quenching unit further comprises:
a. a base portion, wherein the base portion comprises a dispersion inlet for introducing a dispersion of gelled capsules in a continuous phase into the dispersion channel, a first continuous phase outlet for removing parts of the continuous phase from the dispersion channel, and a cross-flow fluid inlet for introducing the cross-flow fluid into the cross-flow fluid inlet unit; and/or
b. a top portion, wherein the top portion comprises a dispersion outlet for removing a dispersion of gelled capsules in the cross-flow fluid from the dispersion channel and a second continuous phase outlet for removing parts of the continuous phase from the dispersion channel.

14. A capsule production device comprising:
a. a capsule gelation quenching unit according to claim 1;
b. an emulsification device being configured for generating the dispersed phase; and
c. a gelation device for gelling capsules comprising a tubular gelation column, a dispersed phase inlet, a continuous phase inlet and an outlet, wherein the dispersed phase inlet is fluidly connected with the emulsification device to introduce the generated dispersed phase into the tubular gelation column; and wherein the tubular gelation column outlet is fluidly connected with the dispersion channel of the capsule gelation quenching unit to introduce the gelled capsules into the dispersion channel.

15. A method for suspending capsule gelation comprising the steps:
Providing a capsule gelation quenching unit according to claim 1;
Guiding a dispersion of gelled capsules in a continuous phase through the tubular column of the capsule gelation quenching unit via the dispersion channel, wherein the continuous phase comprises a first liquid and a matrix-forming agent;
Introducing a cross-flow fluid via the cross-flow fluid inlet unit into the dispersion channel such that the introduced cross-flow fluid flows transversely to the longitudinal direction of the tubular column; and
Removing the cross-flow fluid from the dispersion channel via the first mesh unit of the tubular column.

16. A method for refining capsules, the method comprising:
Providing a capsule gelation quenching unit according to claim 1;
Guiding a dispersion of capsules in a continuous phase through the tubular column of the capsule gelation quenching unit via the dispersion channel, wherein the continuous phase comprises a first liquid and an amount of an impurity, wherein the impurity has a smaller particle size than the capsules;
Introducing a cross-flow fluid via the cross-flow fluid inlet unit into the dispersion channel such that the introduced cross-flow fluid flows transversely to the longitudinal direction of the tubular column; and
Removing the cross-flow fluid from the dispersion channel via the first mesh unit of the tubular column, thereby reducing the amount of the impurity in the continuous phase.

17. The capsule gelation quenching unit according to claim 4, wherein the inlet tube is coaxial with the dispersion channel and/or the tubular column.
